(19) United States
(12) Patent Application Publication
(10) Pub. No.: US 2007/0194058 A1
(43) Pub. Date: Aug. 23, 2007

(54) Device for the expression and dosed application of a flowable paste-like substance

(76) Inventor: Engelbert Gmeilbauer, Seefeld (DE)

Correspondence Address: WILLIAM COLLARD;COLLARD & ROE, P.C., 1077 NORTHERN BOULEVARD, ROSLYN, NY, 11576, US

(21) Appl. No.: 10/589,327

(22) PCT Filed: Feb. 11, 2005
(86) PCT No.: PCT/EP05/01409

§ 371 Date: Sep. 27, 2006

(30) Foreign Application Priority Data
Feb. 12, 2004 (DE) 20 2004 002 186.2

(51) Int. Cl. B67D 5/52; B67D 5/62; G01F 11/00

(52) U.S. Cl. 222/389; 222/137; 222/146.5

(57) ABSTRACT

The invention relates to an elongated, preferably cylindrical plunger located in a chamber of a cartridge gun for the expression and dosed application of a free-flowing, paste-like substance. The exterior of the plunger comprises two seals that are preferably located in a peripheral groove. To express the contents of fixed cartridges, the plunger is equipped with an additional peripheral sealing ring for sealing purposes.

### TECHNICAL FIELD

The invention relates to a device for the expression and dosed application of a flowable paste-like substance, such as a adhesive/sealing substance, comprising a housing, an accommodating chamber provided for a disposable substance pack and adapted to be opened on at least one end thereof, a discharge nozzle, and a plunger arranged on the other end of the accommodating chamber and being displaceable in the direction of the discharge nozzle, the plunger being operative to directly or indirectly press out the paste-like substance from the discharge nozzle in that the plunger is subjected to a corresponding pressure by use of pressurized air which is generated by a compressor driven by an electric motor connected to an accumulator.

### STATE OF THE ART

A device of the above type for the expression and dosed application of a flowable substances is described e.g. in European Patent Application EP 0 998 983 A2. A further device of this type is described in European Patent Application EP 0 490 555 A1 wherein, however, in contrast to the above mentioned device, the pressure required for pressing out the flowable substance is generated by an inserted CO₂ cartridge instead of using a compressor integrated into the device.

A disadvantage of these known devices resides in that, when film tubes are used in case of disposable substance packs, the pressing process will cause parts of the film tube to be squeezed in between the flat plunger and the inner wall of the accommodating chamber containing the substance packs so that the plunger can be moved on, if at all, only by applying a high pressure to it.

In so-called rigid cartridges wherein the substance to be pressed out is accommodated in a container of a circular cylindrical shape, it frequently happens that the container end facing away from the discharge nozzle has been more or less damaged so that a considerable part of the applied pressurized air will deflagrate without effect and the paste-like substance can thus not be pressed out. Consequently, such a cartridge can normally not be used and will have to be discarded. Further, it will occur ever again that paste-like substance escapes into the cartridge press-out device, entailing the necessity of a time-consuming cleaning process performed on the device.

### SUMMARY OF THE INVENTION

In view of the above, it is the object of the invention to provide a tool in the form of a device for the expression and dosed application of a flowable paste-like substance, such as an adhesive/sealing substance, in such a manner that it can be handled easily and safely, that the paste-like substance can be applied in an unobjectionably uniform manner and that the tool is suited for continuous operation. Further, the tool according to the invention shall be adapted to press out tubular cartridge packs as well as rigid containers of a circular cylindrical shape.

According to the invention, the above object is achieved, in a device for the expression and dosed application of a flowable paste-like substance according to the preamble of claim 1, by the features mentioned in the characterizing part of claim 1.

According to the invention, an elongate plunger provided with two continuous seals on its outer side is arranged for free movement within the accommodating chamber of the device for the expression and dosed application of a flowable paste-like substance. Preferably, in this arrangement, each of the two seals is accommodated within a continuous groove in the region of both ends of a circularly cylindrical plunger.

By providing the plunger as an elongate body, a tilting and resultant jamming of the plunger is precluded. Further, by the continuous seals of the elongate plunger which are arranged in abutment on the inner wall of the accommodating chamber, it is safeguarded that no pressurized air can escape between the plunger and the accommodating chamber.

To be able to press out the paste-like substance from a rigid cartridge in a uniform manner, the upper side of the plunger facing towards the cartridge container is provided with a continuous sealing ring.

The plunger has formed therein an e.g. circularly cylindrical or e.g. frustoconical or otherwise shaped pressure chamber merging into a centrally arranged connector piece having a continuous axial bore therein. For using the inventive device also for pressing out paste-like substances contained in film bags, the continuous axial bore can be closed by a cap nut.

To make it possible that, even in case of damaged plastic containers, it is on the one hand safely precluded that pressurized air can escape between the container and the inner wall of the accommodating chamber and it is on the other hand prevented that, in case of more or less heavily damaged containers, the paste-like substance is urged back into the container while massively contaminating the same, the invention provides the use of a dome-like cap of an elastic rubbery material. In this manner, an absolutely tight closure of the cartridge container is effected, and an undesired leakage of paste-like substance is reliably prevented.

To be able to reliably and safely press out paste-like substances contained in film bags, there is provided, according to an advantageous embodiment of the invention, a disk of a diameter corresponding to the cartridge accommodating chamber and formed with a number of radial recesses and with a central opening having a diameter substantially corresponding to the diameter of the axial bore in the connector piece. By way of alternative to the above described disk, use can be made of a circularly cylindrical crown made of elastically resilient material and comprising a number of axial recesses.

Further embodiments and variants of the device according to the invention are indicated in the further claims.

### DESCRIPTION OF THE DRAWINGS

In the drawings as listed hereunder, the following is shown:

FIG. 1 is a simplified, schematic, perspective general view of a device for the expression and dosed application of a flowable paste-like substance;

FIGS. 2a and 2b are a perspective view of an elongate plunger and a sectional view thereof, respectively, said views being not true to scale;

FIG. 3 is a sectional view of a rod;

FIGS. 4 and 5 are views of a disk and of a crown-like member of elastically resilient material, respectively;

FIGS. 6a to 6c are views of a dome-like cap prior to mounting to a damaged rigid cartridge (FIG. 6b), during the mounting (FIG. 6c) and after the mounting (FIG. 6a);

FIG. 7 is a sectional view of a novel compressor;

FIG. 8 is a view of a device for the simultaneous expression and dosed application of two different paste-like substances;

FIG. 9a is a perspective view of a heating means for use in devices for the expression of paste-like substances;

FIG. 9b is a view of a heating means mounted to an expression device, and

FIGS. 10 and 11 are views of “cartridge press-out devices” with one or several commercially available CO₂ cartridges connected thereto.

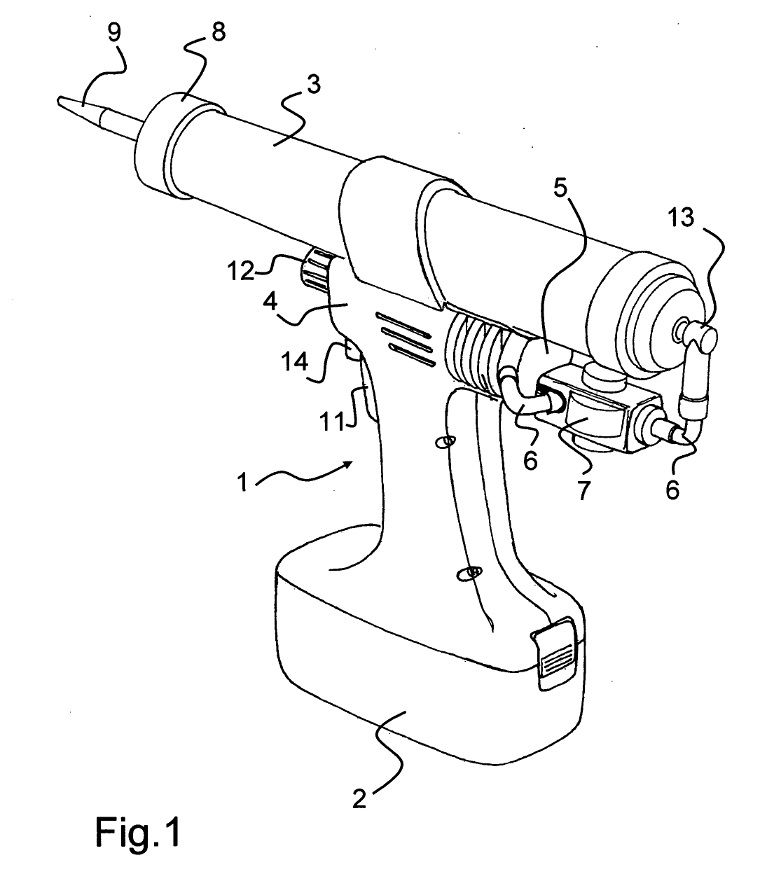

### DESCRIPTION OF THE INVENTION

A tool in the form of a device for the expression and dosed application of a paste-like substance comprises a housing, generally designated by reference numeral 1, which at lower portion thereof is provided with a detachable accumulator 2 and which on the top is provided with an accommodating chamber 3 for film bags or cartridges filled with a paste-like substance. Integrated into housing 1 is an electric motor having connected thereto a commercially available small-sized compressor 5 which is connected to the cartridge accommodating chamber via tubes or hoses 6. At an intermediate position, an electric valve 7 is arranged for pressure release, which valve is operable by a switch 14. As an alternative to the electric valve, a mechanical discharge valve can be integrated into switch 14.

For closing the accommodating chamber 3, there is provided a cap nut 8 formed with a small central opening leading into a projecting discharge nozzle 9 or into a projecting discharge nozzle 51 of the cartridge itself, the latter nozzle being not shown (see FIG. 6c instead). Further, an on/off switch 11, a pressure regulator 12 and a back-check valve 13 are provided.

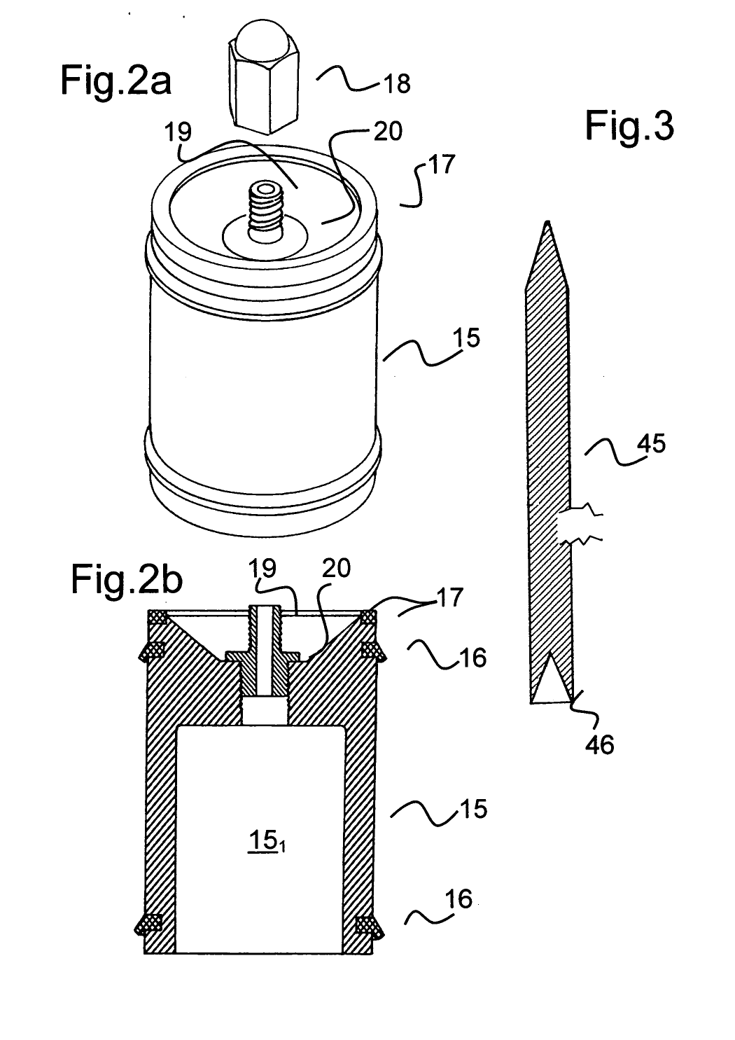

The cartridge accommodating chamber 3 is designed as a pressure chamber accommodating an elongate plunger 15 (FIG. 2a) arranged for free movement in the longitudinal direction of accommodating chamber 3. As evident from the sectional view of FIG. 2b, in the region of the two ends of plunger 15, seals 16 are provided which preferably are arranged in grooves, the latter not shown in greater detail. By the two continuous seals 16, the elongate plunger 15 is sealed in two regions against leakage of pressurized air. Thus, by means of plunger 15, so-called cartridge bags can be pressed out. To make it possible that paste-like substances can be pressed out from rigid cartridge containers in an unobjectionable manner, an additional continuous sealing ring 17 is provided on the upper side of plunger 15.

Internally of the plunger, a pressure chamber 15₁ is formed which in FIG. 2b substantially has the shape of a circular cylinder. Alternatively, the pressure chamber can also have a substantially frustoconical shape as well as any other desired shape. As further evident from FIG. 2b, pressure chamber 15, merges into a centrally arranged connector piece 20 provided with a continuous axial bore 19 extending centrally therethrough. The upper portion of connector piece 20 is formed with an external thread which is adapted, as indicated in FIG. 2a, for threaded engagement with a cap nut 18 which, to accomplish a reliable sealing effect, is provided with an inner sealing, not specifically shown. For pressing out paste-like substance from a rigid cartridge container, cap nut 18 must be screwed into place.

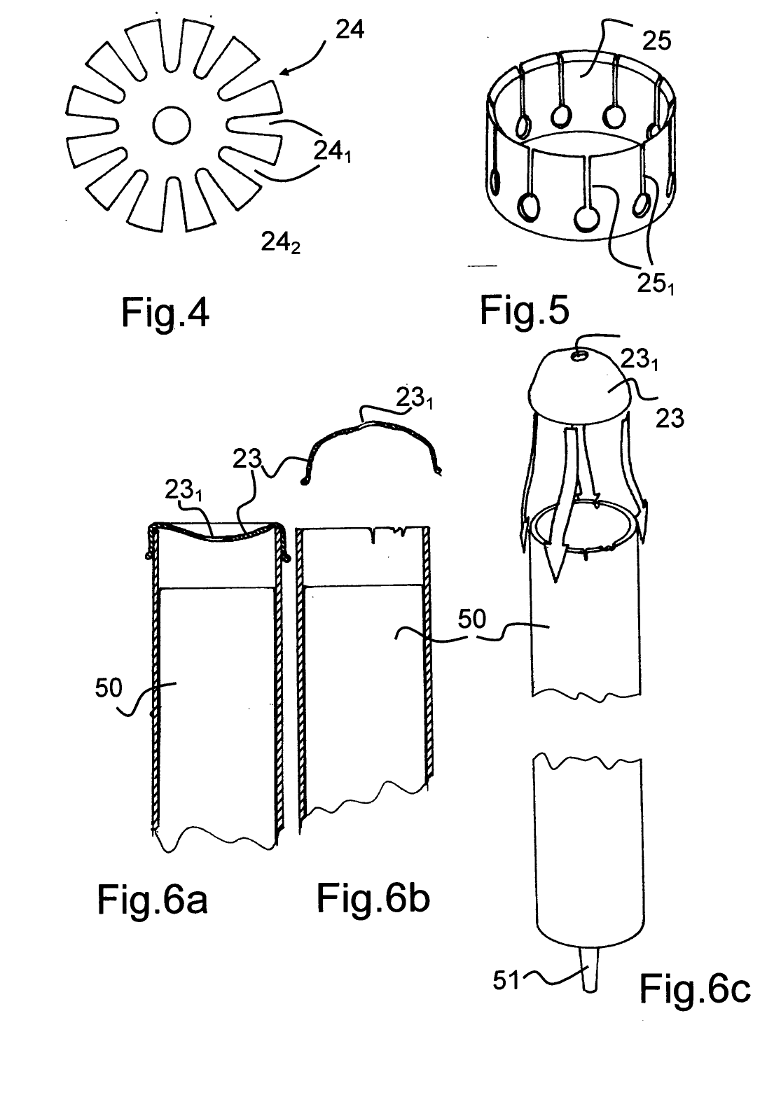

Additionally, to safeguard that paste-like substance contained in film bags is correctly pressed out, a disk 24 of elastically resilient material is provided as schematically illustrated in FIG. 4, said disk being formed with a central opening 24₂ adapted to the outer diameter of connector piece 20, and with a number of radial recesses 24₁.

By the provision of disk 24, it is precluded that that, when pressing out paste-like substance from a film bag, parts of the bag being pressed out may enter the space between the plunger 15 and the inner wall of accommodating chamber 3. For the same purpose, use can be made also of a circularly cylindrical crown 25, shown in FIG. 5, in which a number of radial slots 25₁ are formed.

In order to prevent, in rigid cartridge containers 50 wherein the edge opposite the discharge nozzle 51 has been damaged, that pressurized air will escape between the cartridge container and the accommodating chamber, there is provided, according to an advantageous embodiment of the invention, a dome-shaped cap 23 made of an elastic rubbery material and having a central opening 23₁. Damages of the type referred to above are schematically indicated in FIGS. 6b and 6c on the upper edge of cartridge container 50. FIG. 6c further schematically indicates the manner in which the dome-shaped cap 23 can be pulled over the damaged end of a cartridge container 50. FIG. 6a illustrates a cap 23 as correctly mounted. To prevent contamination of paste-like substance which occasionally happens to leak out of a rigid cartridge container, it has been proven useful to mount the dome-shaped cap 23 even in case of undamaged or only slightly damaged cartridge containers.

For the practical use of a device for the expression and dosed application of a paste-like substance, the following process is provided. Prior to insertion of a rigid cartridge 50 with discharge nozzle 51, the cap nut 8 has to be screwed off, and the cartridge 50 will be inserted and the cap nut 8 will be screwed on again. By actuating the on/off switch 11, the electric motor 4 driving the compressor 5 will be switched on. Thus, pressurized air will be generated and be supplied via the tube or hose conduits 6 into the rear part of the cartridge accommodating chamber 3.

When the obtained pressure is large enough, an adhesive bead is pressed in a uniform manner from the cartridge discharge nozzle 51. Upon release of the switch 11, the back-check valve 13 prevents a return flow of pressurized air back into the compressor 5. However, the pressure will slowly decrease, and the discharge of the adhesive bead is decelerated down to the point of standstill. If it is desired to bring the adhesive bead to a standstill immediately, a discharge valve can be opened by actuation of an additional switch 14. The pressure can be suitably adjusted, i.e. increased or decreased, by means of pressure regulator 12 so that the adhesive bead will be pressed out at a higher or lower speed.

Depending on the type of the cartridge used, a different technical process will have to be performed. When using a film bag, the cap nut 18 has to remain on the plunger 15. Thus, the axial bore 19 remains closed, and pressure is built up in the pressure chamber 15₁ of the plunger. When a predetermined pressure is reached, the plunger 15 is pushed forwards. Thereby, the film bag is pressed together, and the adhesive/sealing substance is pressed out via the discharge nozzle 9.

When using a rigid cartridge, i.e. a cartridge comprising a rigid container, the cap nut 18 in the center of the plunger has to be removed so that the connector piece 20 projecting slightly above the plunger 15 and provided with the continuous axial bore 19 will be exposed. During the insertion of the rigid cartridge, the protective film provided at the rear end will be perforated, thus offering access to the cover of the actual adhesive substance. The pressurized air built up in the pressurized air chamber 15₁ of plunger 15 will flow through the axial bore 19 and build up a corresponding pressure behind the cartridge 50. Thereby, the adhesive substance will be pressed in the forward direction out of the cartridge discharge nozzle 51.

In situations where, after use of a rigid cartridge, a film bag or cartridge bag shall be used, the following problem arises. The plunger 15 has taken a fully rearward position and can be moved to the forward position by pressurized air only after the axial bore 19 will have been closed. Since, however, in this position of the plunger 15, the cap nut 18 cannot be screwed on, the bore/opening 19 will first be closed with the aid of a correspondingly long rod 40 having a recess 41 on one end; at the same time, the device will be switched on. By the developing pressure, the plunger 15 is slowly advanced far enough in the forward direction for allowing the cap nut 18 to be screwed on.

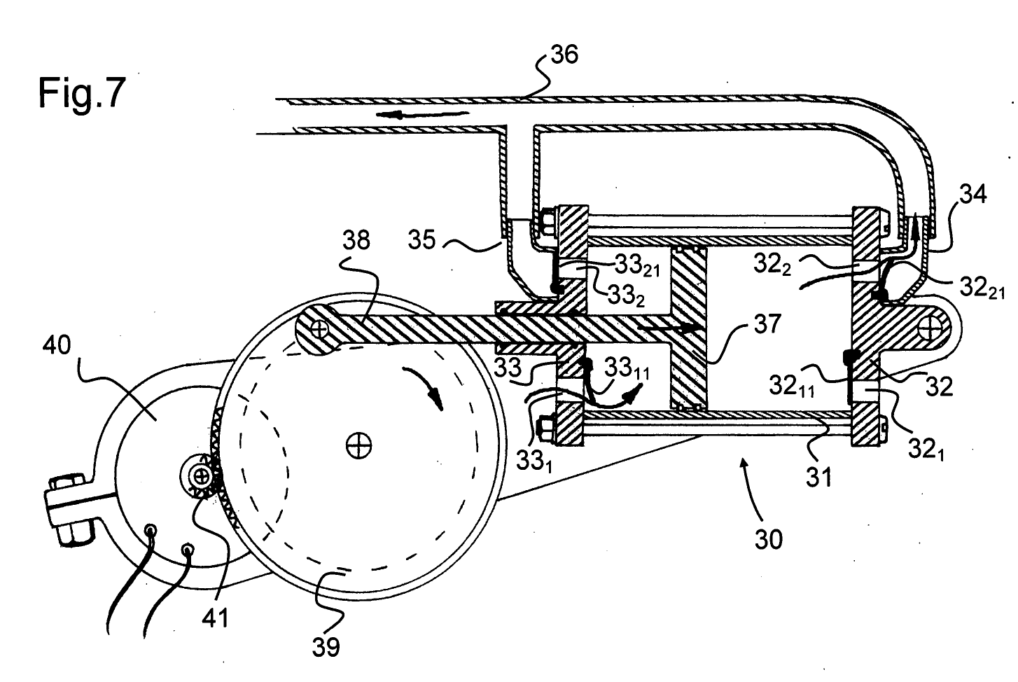

With reference to FIG. 7, a compressor 30 will be described hereunder which can be used in an advantageous manner in the device of the invention, particularly in situations where a larger quantity of pressurized air is required for dosed expression of two cartridges at the same time. The novel compressor 30 comprises a cylinder 31 having one of its ends supported in a fixed position; in the sectional view of cylinder 31, this support is schematically marked by an encircled cross above reference numeral 32.

Two mutually opposite end portions 32 and 33, exemplified as formed by the bottom and the cover of the cylinder, are provided with respective inlet openings 32₁ and 33₁, respectively, and outlet openings 32₂ and 33₂, respectively. The inlet openings 32₁ and 33₁ have assigned thereto a respective inlet valve 32₁₁ or 33₁₁, while the outlet openings 32₂ and 33₂ have assigned thereto a respective outlet valve 32₂₁ or 33₂₁.

A piston 37 is connected via a piston rod 38 to an eccentric disk 39 which in turn is driven by a pinion 41 provided on the output shaft of a motor 40. In the rotational direction indicated by an arrow on eccentric disk 39, piston 57 is driven in the direction indicated by an arrow to the right-hand side in FIG. 7. When this movement of piston 37 takes place, inlet valve 33₁₁ is opened, and through outlet valve 32₂₁ pressurized air is led via a connection member 34 into a pressurized air conduit 36.

After reaching the dead center located on the left side in FIG. 7, piston 37 is moved to the left whereby inlet valve 33₁₁ and outlet valve 32₂₁ will be closed and inlet valve 32₁₁ and outlet valve 33₂₁ will be opened. Thereby, air is conveyed via a connection member 35 into the same pressure line 36. This means that, at each rotation of eccentric disk 39, piston 37 will perform a dual stroke so that, as compared to the conventional compressors used up to now, twice the previous air quantity will be conveyed.

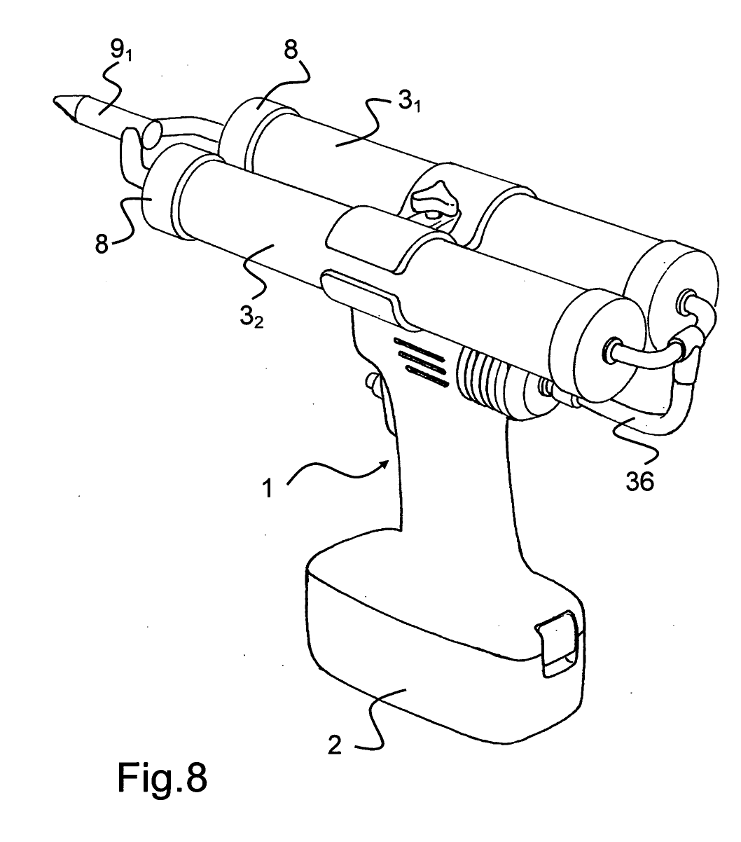

If, as in the embodiment illustrated in FIG. 8, a device for the expression and dosed application of a paste-like substance is provided with two accommodating chambers 3₁ and 3₂, one of the accommodating chambers, e.g. 3₁, can accommodate a cartridge filled with adhesive, and the other accommodating chamber 3₂ can accommodate a cartridge filled with a hardener. As soon as the compressor 30 has built up a suitable pressure, e.g. identical quantities of the substance can be squeezed out from both cartridges; subsequently these quantities will be mixed in a discharge nozzle 9₁ and be applied as an adhesive bead to the desired site. The pressurizes air required for simultaneously pressing out the contents of two cartridges can be generated by the compressor 30 described with reference to FIG. 7.

The effort to perform as many processes as possible in a more rapid manner has led to the development of a sealing/adhesive substance adapted to harden quickly. However, a disadvantage of this product resides in that this material is very hard at the usual ambient temperatures. To lend the material the required flowability for processing, the material has to be heated correspondingly. Up to now, for this purpose, the above-mentioned quick-hardening sealing/adhesive substance has been heated in separate heating means until reaching the flowability necessitated for discharging it.

After the sealing/adhesive substance had been sufficiently heated, the cartridge was removed from the heating means and introduced into the not preheated and thus comparatively cool “cartridge press-out device”. Consequently, in many cases, the heated substance happened to cool down so very rapidly that it had to be removed from the cartridge press-out device before termination of the respective working step and had to be heated again, which course took a corresponding length of time.

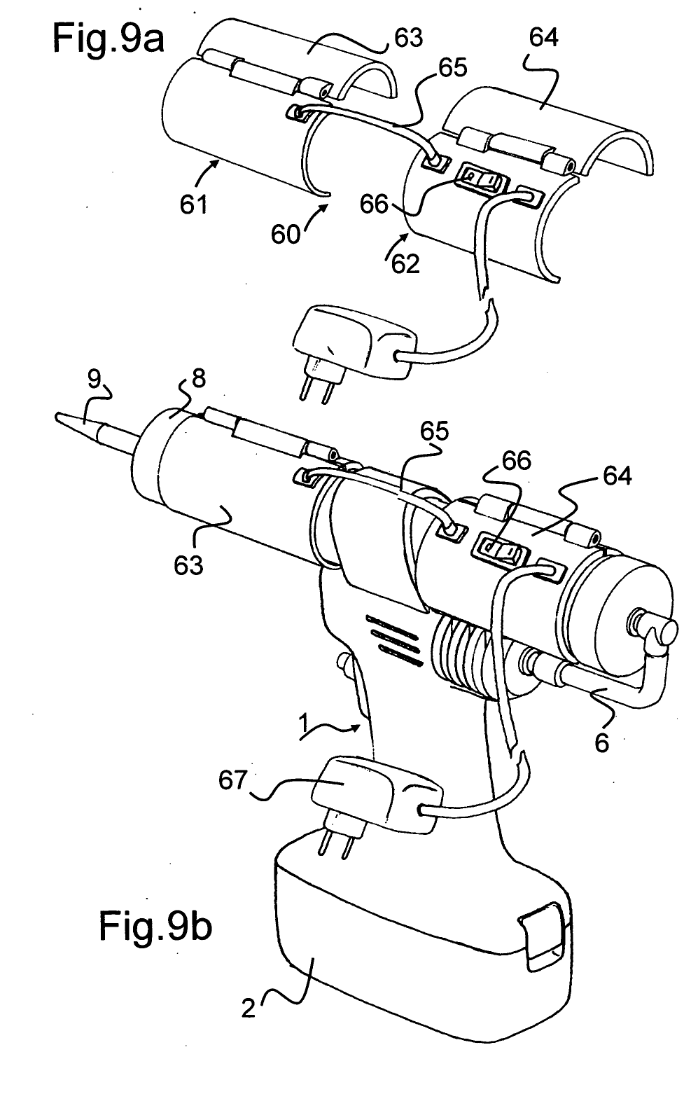

To abbreviate the heating of this quick-hardening sealing/adhesive substance, there has been developed a novel detachable heater device 60 surrounding the accommodating chamber of a cartridge press-out device (FIG. 9a). This heater device 60 comprises two mutually attached circularly cylindrical heater bodies 61,62 foldable into an opened position. Each of the two heater bodies 61,62 comprises two double-walled half shells 63 and 64 which form a respective circularly cylindrical hollow body and are articulated to each other. Arranged internally of the double-walled heating shells 63 and 64 are heating wires which can be energized by an accumulator or by the power network.

The embodiment illustrated in FIGS. 9a and 9b is provided with a mains plug 67 with integrated transformer for reducing the voltage. Further, an on/off switch 66 is provided in half shell 64. The two heater bodies 61,62 are connected to each other by a connection cable 65 reinforced by e.g. steel mesh.

In FIG. 9, the novel heater device 60 is shown to surround the accommodating chamber of a schematically illustrated cartridge press-out device. A cartridge filled with a hard adhesive/sealing substance can be inserted into a cartridge press-out device equipped in the above manner so as to bring the substance to the operating temperature at which it is flowable.

During the length of the heat-up process, which—depending on the respective ambient temperature—can be in the magnitude of e.g. 10 to 15 minutes, corresponding preparatory measures can be taken during the heating of the adhesive/sealing substance.

Since, simultaneously with the heating of the adhesive/sealing substance, the cartridge press-out device is heated along with the substance, it is guaranteed that a longer working process can be completely performed without the danger of the adhesive substance cooling down so massively that the working process has to be interrupted. Therefore, using the novel heater device 60, the process of applying the adhesive substance in the form of an adhesive bead can be considerable abbreviated, and the pressing-out and dosed application adhesive/sealing substance can thus be performed within a considerably shorter time period.

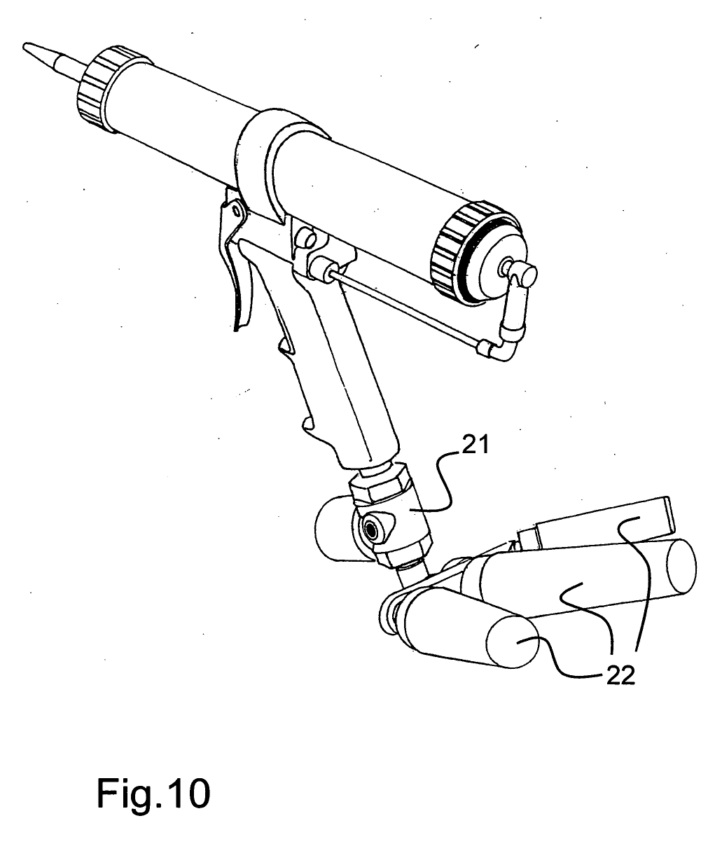

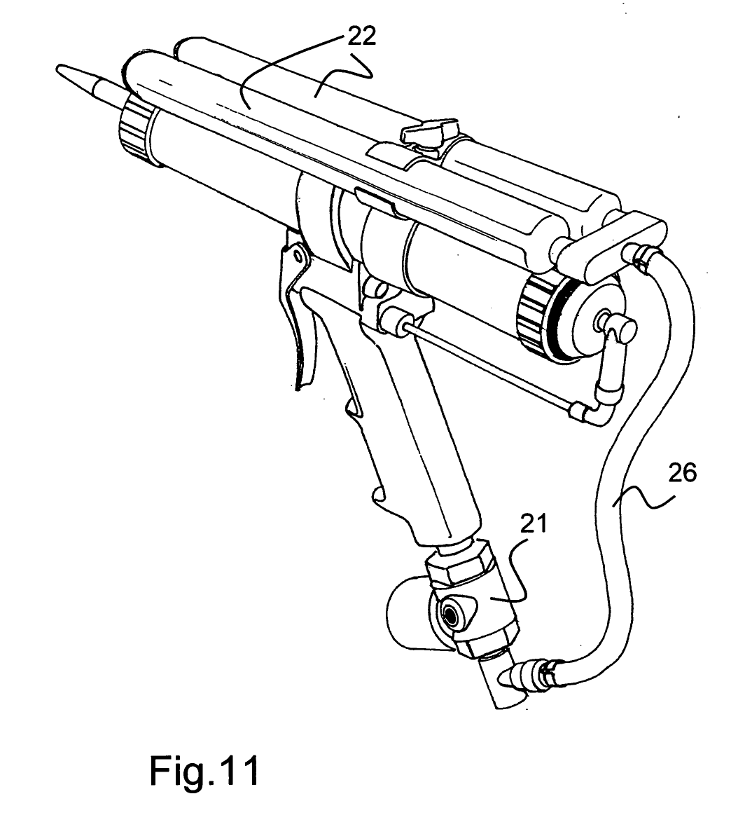

In FIGS. 10 and 11, “cartridge guns” are shown wherein, instead of a compressor, at least one commercially available CO₂ cartridge is connected via a pressure reducer 21. In the embodiment shown in FIG. 11, two commercially available CO₂ cartridges 22 are mounted in the accommodating chamber 3 of a corresponding “cartridge gun” and connected to the “cartridge gun” via a hose connection 26 and a pressure reducer 21.

### LIST OF REFERENCE NUMERALS

1 housing
2 accumulator
3 accommodating chamber
4 electric motor
5 small-sized compressor
6 tubes/hoses
7 electric valve
8 cap nut
9 discharge nozzle
11 switch
12 pressure regulator
13 back-check valve
12
14 switch
15 plunger
16 seal
17 sealing ring
18 cap nut
19 bore
20 connector piece
20₁ external thread
21 pressure reducer
22 cartridge
23 cap
23₁ opening in 23
24 disk
24₁ radial recesses
24₂ central opening in 24
25 crown
25₁ recesses in 25
26 hose connection
30 compressor
31 cylinder
32,33 end portion of 31
32₁,33₁ inlet
32₂,33₂ outlet
32₁₁,33₁₁ inlet valve
32₂₁,33₂₁ outlet valve
34,35 connection member
36 pressure line
37 piston
38 piston rod
39 eccentric disk
40 electric motor
41 pinion
45 rod
46 recess in 40
50 cartridge container
51 discharge nozzle on 50
60 heater device
61,62 heater bodies
63,64 double-walled half shells
65 connection cable
66 switch
67 mains plug with integrated transformer

1-16. (canceled)

17. A device for the expression and dosed application of a flowable paste-like substance, comprising a housing (1), an accommodating chamber (3) provided for a disposable substance pack and adapted to be opened on at least one end thereof, a discharge nozzle, and a plunger provided on the other end of the accommodating chamber (3) and being displaceable in the direction of the discharge nozzle, the plunger being provided with at least one continuous seal (16) and being operative to press out the paste-like substance from the discharge nozzle (9) by use of pressurized air, said device further comprising a compressor (5) driven by an electric motor (4), wherein the elongate plunger (15) has formed therein a pressure chamber (15i) having a substantially circularly cylindrical shape or frustoconical shape and merging into a centrally arranged connector piece (20) provided with a continuous axial bore (19) extending therethrough which is closeable by a nut cap (18).

18. The device according to claim 17, wherein an additional continuous sealing ring (17) on the upper side of the plunger (15) facing towards a rigid cartridge container (50), provided for sealing while substance is being pressed out of rigid cartridge containers.

19. The device according to claim 17, wherein a recess (41) provided at one end of a rod (40) for closing the axial bore (19) in the connector piece (20).

20. The device according to claim 17, wherein a dome-shaped cap (23) made of an elastic rubbery material for tight closure of the end of a rigid cartridge container (50) facing away from the discharge nozzle (51).

21. The device according to claim 20, wherein the dome-shaped cap (23) is formed with a central opening (23₁).

22. The device according to claim 17, wherein a disk (24) made of an elastically resilient material, having a diameter corresponding to the cartridge accommodating chamber (3) provided with a number of radial recesses (24i) and with a central opening (24₂) having a diameter substantially corresponding to the diameter of the bore (19) in the connector piece (20).

23. The device according to claim 17, comprising a circularly cylindrical crown (25) made of elastically resilient material and comprising a number of axial recesses (25₁).

24. The device according to claim 17, comprising a back-check valve 20 (13) for preventing a return flow of pressurized air into the compressor (5).

25. The device according to claim 17, comprising a compressor (30) comprising a cylinder (31) having one of its ends supported in a fixed position, the mutually opposite end portions (32;33) of the cylinder (31) being provided with respectively one inlet valve (32₁;33₁) and respectively one outlet valve (32₂;33₂), and the cylinder (31) having arranged therein a reciprocable piston (37) driven by an eccentric disk (39), and comprising connection members (34;35) arranged at the two outlet valves (32₂;33₂) and connected to a pressure line (36).

26. A heater device for a device according claim 17, wherein the heater device is provided as a removable heater device (60) surrounding the accommodating chamber (3).

27. The heater device according to claim 26, wherein the heater device (60) comprises two mutually attached circularly cylindrical heater bodies (61;62) foldable into an opened position.

28. The heater device according to claim 27, wherein the two heater bodies (61;62) each comprise two double-walled half shells (63;64) forming respective circularly cylindrical hollow bodies and being articulated to each other, the half shells (63;64) having heater wires arranged internally thereof which are energized by an accumulator or the power grid.

29. The device according to claim 17, comprising at least one commercially available CO₂ cartridge (22) connectable via a pressure reducer (21).

30. The device according to claim 17, comprising one and preferably two or more CO₂ cartridges (22) mounted in the accommodating chamber (3) which can be connected via a hose connection (26) and a pressure reducer (21).
